(19) United States
(12) Patent Application Publication
(10) Pub. No.: US 2003/0120827 A1
(43) Pub. Date: Jun. 26, 2003

(54) Method and apparatus for automatically detecting machine states during an operating system installation through a network

(76) Inventors: Dominic Fulginiti, Sacramento, CA (US); Roland P. Wooster, Folsom, CA (US); Paul T. Bloomquist, El Dorado Hills, CA (US); John P. Hurlimann, Folsom, CA (US)

Correspondence Address: Christian A. Nicholes, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/027,728

(22) Filed: Dec. 20, 2001

(51) Int. Cl. G06F 9/00

(52) U.S. Cl. 709/319

(57) ABSTRACT

An indication from a device is received through a network. Upon a determination from the indication that the device is in a state in which a first system has not been loaded on the device, the device is instructed through the network to load the first system. Upon receiving through the network from the device an indication that the first system has been loaded, it is indicated through a (possibly remote) user interface that the device is in an “available” state in which the device is available to load an operating system selectable through the user interface. In one embodiment, upon a selection of an operating system, the device is instructed through the network to load the operating system. Upon receiving through the network from the device an indication that the operating system has been loaded, it is indicated through the user interface that the device is in a “provisioned” state in which an operating system has been loaded for the device. In one embodiment, the device may be instructed through the network to return to an “unprovisioned” and “available” state.

### FIELD OF THE INVENTION

The invention relates to the fields of operating systems and networks. More specifically, the invention relates to installing an operating system through a network.

### BACKGROUND OF THE INVENTION

The widespread use of computer systems has become common in the modem business environment. At a single business site, there may be dozens or even hundreds of such computer workstations. Typically, in order to be usable, each of these workstations will need to first be provisioned with an operating system. Manual installation of operating systems on each of these workstations individually can be a costly and time-consuming endeavor.

To reduce the time required to install operating systems on many computer workstations, the installation process may be automated. Typically, the automation process involves planning, prior to the actual installation, which of a number of operating systems will be installed on any given workstation. This pre-installation planning introduces numerous opportunities for human error in configuration. Additionally, even automated operating system installations frequently require an operator to be physically present at the workstation on which an operating system is being installed to take action at various points in the installation process, such as rebooting the workstation. Furthermore, once an operating system has been installed on a workstation, installing a different operating system on the workstation usually requires an operator to be physically present. All of these factors tend to defeat the reasons for automating the installation process.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates the various states that a device may enter during the installation process, according to one embodiment;

FIG. 2 illustrates the various signals that may be passed between a server and a device during the installation process, according to one embodiment;

FIG. 3 illustrates a flow diagram for installing an operating system on a device over a network, according to one embodiment;

FIG. 4 illustrates a flow diagram for installing a selected operating system on the device through a network, according to one embodiment;

FIG. 5 illustrates a flow diagram for returning a device to a state in which an operating system has not been selected for the device, according to one embodiment;

FIG. 6 illustrates a flow diagram for installing an operating system from a server through a network, according to one embodiment;

FIG. 7 illustrates a flow diagram for unprovisioning an operating system through a network from a server, according to one embodiment;

FIG. 8 illustrates a system for installing an operating system on a device through a network, according to one embodiment; and

FIG. 9 illustrates a system for installing an operating system selectable through a user interface from a server through a network, according to one embodiment.

### DETAILED DESCRIPTION OF THE INVENTION

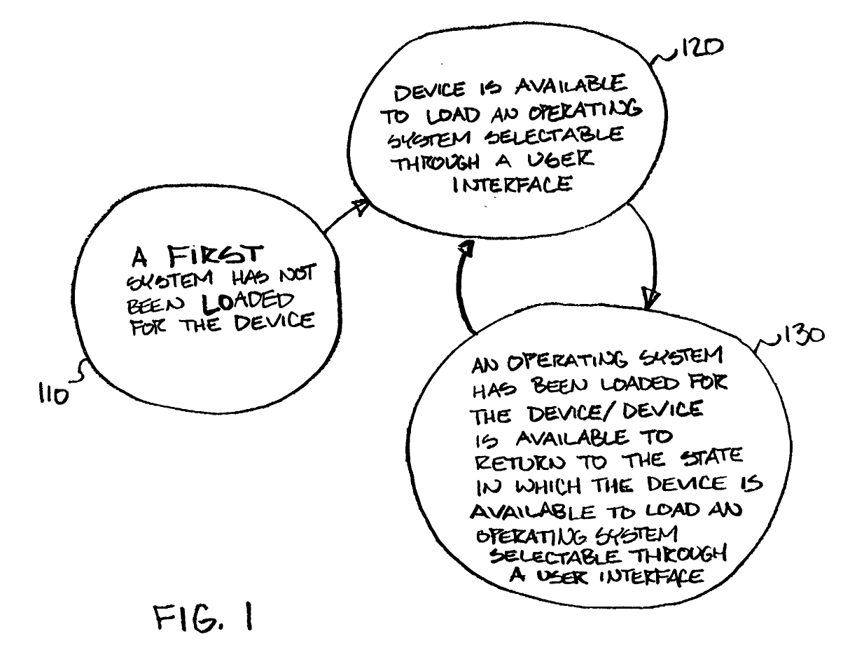

FIG. 1 illustrates the various states that a device may enter during the installation process, according to one embodiment. In one embodiment, the device is a general-purpose computer, such as a personal desktop microcomputer. However, the device may be any device susceptible to the installation of an operating system through a network. For example, a device may be a handheld computer, a personal digital assistant, a cellular telephone, or a network workstation.

An operating system is a set of instructions executable by a device that, when executed by a device, controls the operation of the device and directs the processing of programs (as by assigning storage space in memory and controlling input and output functions). Unix is an exemplary operating system.

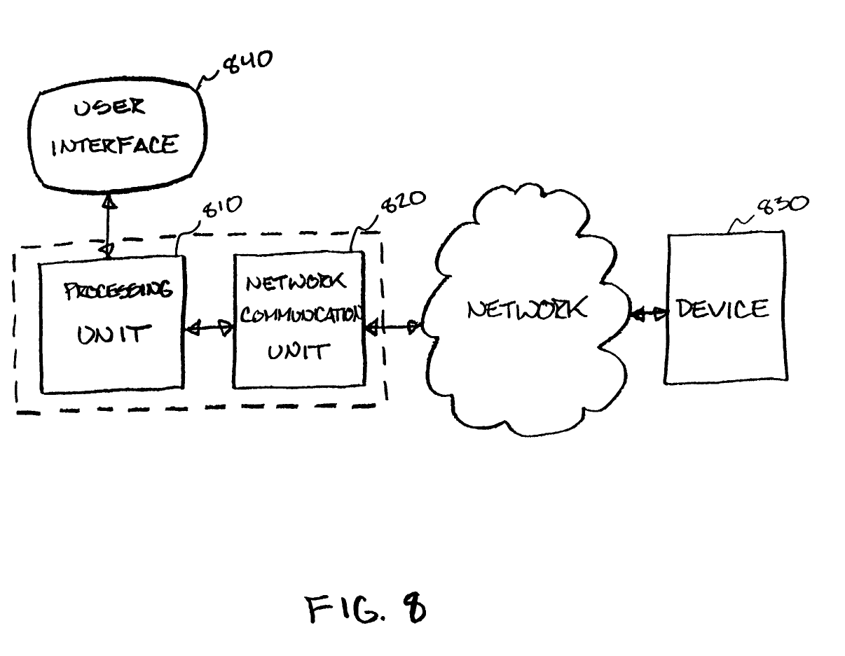

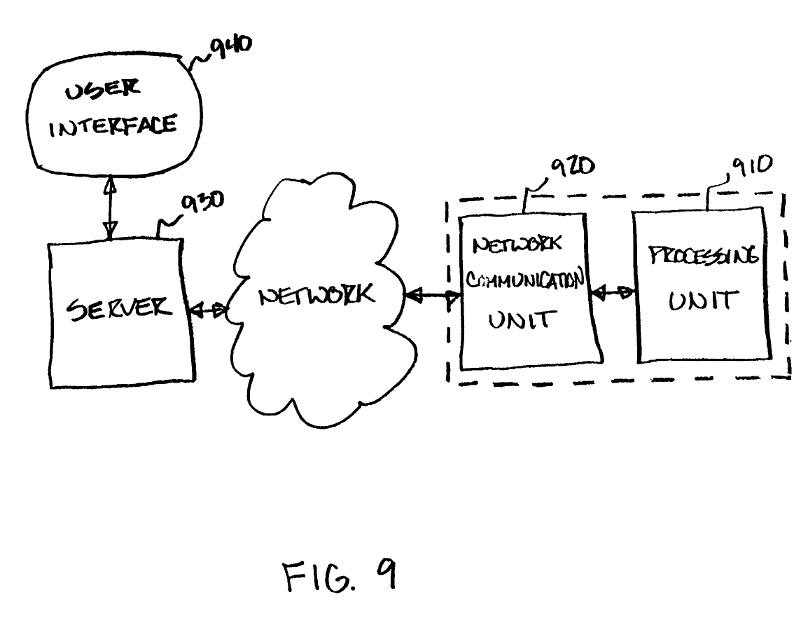

A network is two or more devices linked together to communicate with one another, including the structure used to link the devices. For example, a network may be a local area network (“LAN”) of computers at one business site communicatively linked with twisted pair or fiber-optic cable. For one portrayal of a device linked to a network, see FIGS. 8 and 9 with accompanying description. Of course, the medium used to communicatively link devices together in a network need not be a guided medium physically linking the devices together. Devices may be “wirelessly” linked through electromagnetic waves such as radio waves, microwaves, or infrared light. The devices in a network need not be directly linked together; devices may be indirectly linked together, for example, through a series of network routers or even orbital satellites. The Internet is an exemplary network.

A device in a network may interface with the network through a network communication unit such as a network interface card. A network interface card is an electronic unit, sometimes in the form of an expansion board which may be inserted into an expansion slot on a computer motherboard, containing circuitry that permits a device connected with the network interface card to send communicative signals through the network. An Ethernet card is an example of a network interface card.

When a device has entered state 110, a first system has not been loaded for the device. From state 110, a device may enter state 120, in which the device is available to load an operating system selectable through a user interface. From state 120 a device may enter state 130, in which an operating system has been loaded for the device. In state 130, the device is also available to return to state 120, in which the device is available to load an operating system selectable through the user interface. Each of these states will be described in further detail below.

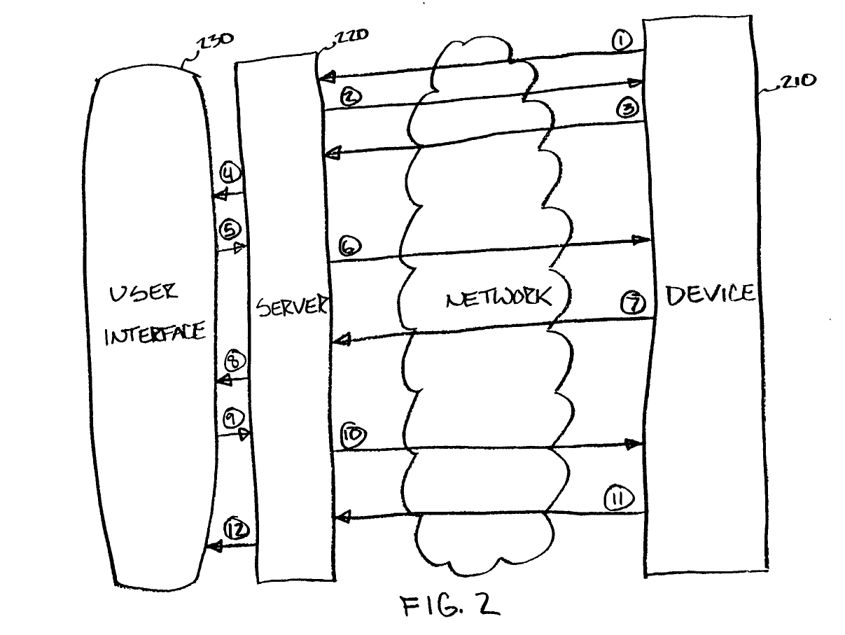

FIG. 2 illustrates the various signals that may be passed between a server and a device during the installation process, according to one embodiment. At the beginning of the installation process, device 210 has no operating system installed. Device 210 is configured through its basic input/output system (“BIOS”) to boot to its network interface card prior to booting from any drive present on the device. Ways of configuring a device through a BIOS to boot from a network interface card prior to booting from a drive are well-known in the art and are therefore not described in detail here. When device 210 is attached to the network and is booted from its network card, device 210 sends an indication of its existence over the network to server 220, shown as signal 1. A server may be a device, usually a computer, communicatively linked to a network to manage network resources (such as other devices). A server may also be a process running on a device. In one embodiment, server 220 is a Dynamic Host Configuration Protocol (“DHCP”) server. The indication sent to server 220 uniquely identifies device 210 by the Media Access Control (“MAC”) address of the network interface card of device 210. Because server 220 does not recognize the identity of device 210, server 220 determines from the indication that device 210 is in a state in which a first system had not been loaded for device 210. The server 220 instructs device 210 to load the first system, shown at signal 2. In one embodiment, the first system is a mini-kernel. In one embodiment, the mini-kernel is a subset of a Linux operating system kernel and environment. In one embodiment, the mini-kernel includes an agent process that communicates with server 220.

Device 210 receives the instruction to load the first system and loads the first system from server 220. In one embodiment, the first system is loaded into the random access memory (“RAM”) of device 210. After device 210 has loaded the first system, device 210 sends an indication through the network to server 220 that the first system has been loaded. When server 220 receives the indication that the first system has been loaded, server 220 indicates through a user interface 230 that device 210 is in a state in which the device is available to load an operating system selectable through the user interface 230, shown at signal 4. This state corresponds to state 120 of FIG. 1. In one embodiment, user interface 230 is accessed through a web browser. In one embodiment, user interface 230 is accessible through the Internet. In one embodiment, user interface 230 lists device 210, then available to load a selectable operating system, as an “available device”. It is to be noted that user interface 230 may be at a location physically remote from server 220 and device 210. Thus, a user of user interface 230 need not be physically present at the location of either device 210 or server 220 during interaction through user interface 230.

In one embodiment, the “available device” listed in user interface 230 is an object. In one embodiment, the object includes a method, visible to a user, labeled “provision”. By activating the method, the user may select an operating system for device 210. Again, it is to be noted that a user of user interface 230 need not be physically present at the location of either device 210 or server 220 during activation of the “provision” method through user interface 230. It is apparent, then, that the user activating the “provision” method may be a different person than a person who physically installed device 210 (e.g., plugged-in device 210, powered-on device 210, etc.). In one embodiment, the user may also enter other information about device 210, such as a workstation name. The operating system selected through user interface 230 is sent to server 220, shown at signal 5. In one embodiment, server 220 creates an entry for device 210 in DHCP indexed by the MAC of device 210. Server 220 instructs device 210 to load the operating system through the network, shown at signal 6. In one embodiment, this is accomplished by server 220 instructing device 210 to reboot. Device 210 will boot from its network card, as configured by its BIOS. When server 220 receives the boot request from device 210, server 220 recognizes device 210 and instructs device 210 to boot from a file that will install the operating system selected through user interface 230 on device 210. When device 210 reboots it will reboot from its network card and server 220 will instruct device 210 whether to boot from a hard drive local on device 210 or an installation file. If, for some reason, server 220 is unavailable, then the BIOS of device 210 will instruct device 210 to boot from the next source listed in the BIOS; usually a local hard drive.

Once device 210 has loaded the selected operating system from server 220, device 210 sends through the network to server 220 an indication that the operating system has been loaded, shown at signal 7. In one embodiment, this indication is sent by an operating system-specific agent process running on device 210 that was installed with the operating system. When server 220 receives the indication from device 210 that the operating system has been loaded, the server 220 indicates through user interface 230 that an operating system has been loaded for the device, shown at signal 8. In one embodiment, sever 220 indicates through user interface 230 which operating system has been installed on device 210. At this point, device 210 is in a state corresponding to state 130 of FIG. 1.

In one embodiment, a device in a state in which an operating system has been loaded for the device is represented through user interface 230 as a “provisioned device”. In one embodiment, a “provisioned device” is an object having a method, visible to a user, labeled “unprovision”. This indicates through user interface 230 that device 210 is in a state in which device 210 is available to return to the state in which an operating system has not been selected for the device. If there is an indication through user interface 230 to return device 210 to the state in which an operating system has not been selected for the device, shown at signal 9, such as by activating the “unprovision” method, then server 220 instructs device 210 through the network to load the first system, shown at signal 10. When device 210 receives the instruction to load the first system then device 210 loads the first system from server 220. Once device 210 has loaded the first system from server 220, then device 210 sends an indication through the network to server 220 that the first system has been loaded, shown at signal 11. When server 220 receives the indication from device 210 that the first system has been loaded, then server 220 indicates through user interface 230 that the device 210 is in a state in which the device is available to load an operating system selectable through user interface 230, shown at signal 12. At this point, device 210 is once again in a state corresponding to state 120 of FIG. 1.

In one embodiment, the “available device” listed in user interface 230 is an object including a method, visible to a user, labeled “treat as already provisioned”. By activating the method, the user may cause device 210 to be placed into state 130 without selecting an operating system for device 210. Activation of this method does not cause an operating system to be installed on device 210, but causes the “available device” listed in user interface 230 to then appear instead as a “provisioned device”. This method may be useful when a device has already had a desirable operating system installed upon it. When device 210 boots while in state 130, device 210 boots from its network card, but is instructed by server 220, which recognizes device 210 as a “provisioned” device, to boot from a local storage medium (e.g., a hard disk drive) of device 210. The “treat as already provisioned” method may be used to move device 210 from state 120 to state 130 without overwriting an operating system already present on the local storage medium. If, as in one embodiment, the first system is loaded into the RAM of device 210 when the first system is loaded, then an operating system already present on the local storage medium will not be overwritten by the loading of the first system. Thus, the “treat as already provisioned” method may be used to recover from an unwanted placement of device 210 into state 120 (e.g. through the activation of the “unprovision” method).

It is apparent that, while the above processes may be initiated by human interaction through user interface 230, the above processes may also be performed automatically without human intervention. The actions that would otherwise be taken by a user through user interface 230 may be incorporated into a script or program that may be executed on server 220 or a machine remote to server 220 that communicates through a network with server 220, such as the machine on which user interface 230 would be presented. These scripts or programs may include schedules of dates and times at which device 210 and other devices are to be provisioned or unprovisioned or otherwise entered into a state. Of course, such scripts or programs may, in one embodiment, operate in conjunction with human interaction through user interface 230. The processes described below may also be automated.

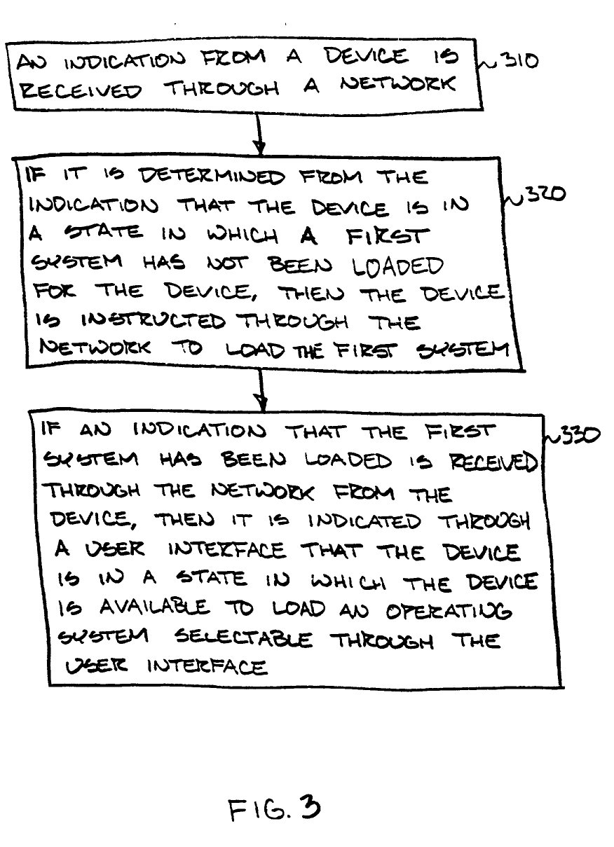

FIG. 3 illustrates a flow diagram for installing an operating system on a device over a network, according to one embodiment. In process block 310, an indication from a device is received through a network. In process block 320, if it is determined from the indication that the device is in a state in which a first system has not been loaded for the device, then the device is instructed through the network to load the first system. In process block 330, if an indication that the first system has been loaded is received through the network from the device, then it is indicated through a user interface that the device is in a state in which the device is available to load an operating system selectable through the user interface.

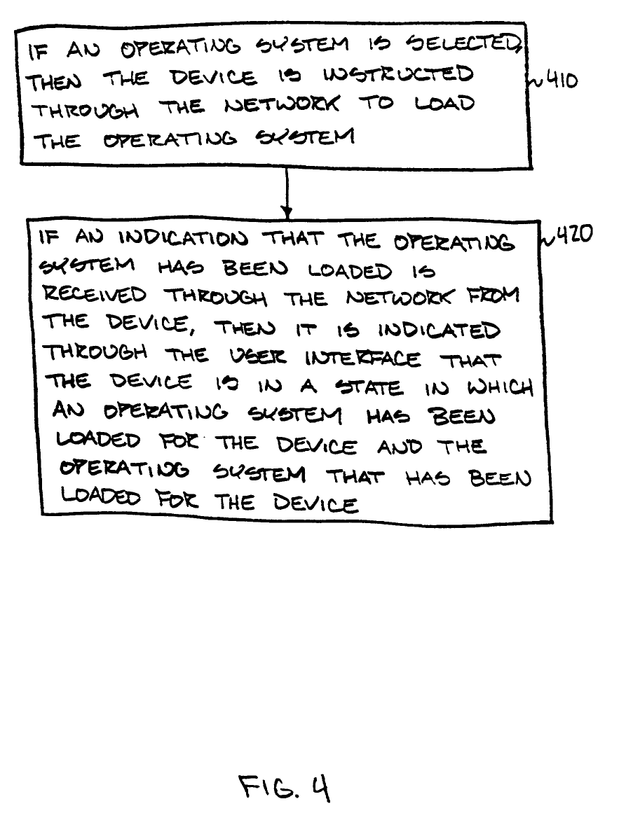

FIG. 4 illustrates a flow diagram for installing a selected operating system on the device through a network, according to one embodiment. In one embodiment, after it is indicated through a user interface that the device is in a state in which the device is available to load an operating system selectable through the user interface, as shown in process block 330 above, then in process block 410, if an operating system is selected, the device is instructed through the network to load the operating system. In process block 420, if an indication that the operating system has been loaded is received through the network from the device, then it is indicated through the user interface that the device is in a state in which an operating system has been loaded for the device. In one embodiment, the operating system that has been loaded for the device is also indicated through the user interface.

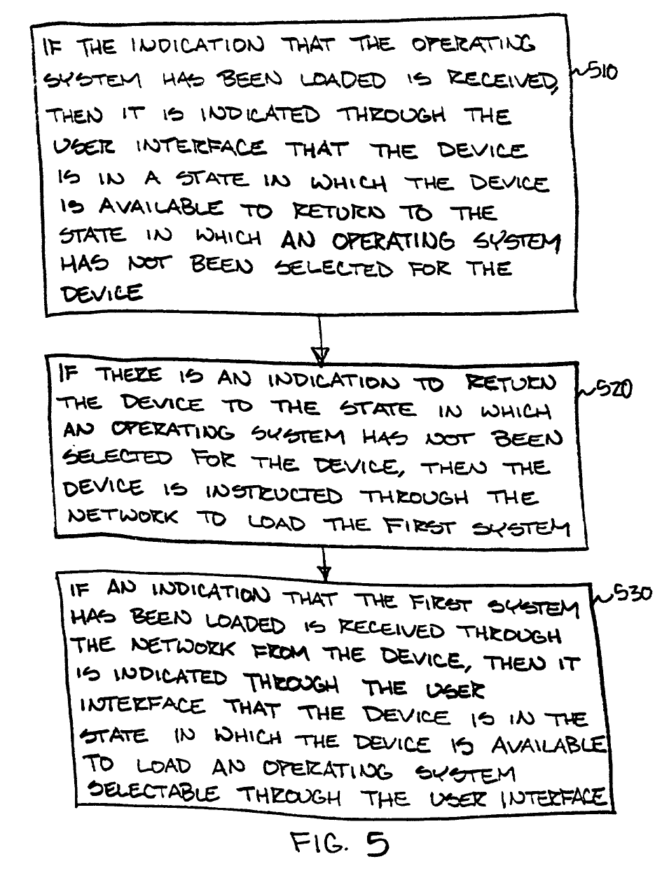

FIG. 5 illustrates a flow diagram for returning a device to a state in which an operating system has not been selected for the device, according to one embodiment. In one embodiment, after it is indicated through the user interface that the device is in a state in which an operating system has been loaded for the device as shown in process block 420 above, then in process block 510, if the indication that the operating system has been loaded is received, it is indicated through the user interface that the device is in a state in which the device is available to return to the state in which a operating system has not been selected for the device. In process block 520, if there is an indication to return the device to the state in which an operating system has not been selected for the device, then the device is instructed through the network to load the first system. Again, in one embodiment, the first system is a Linux mini-kernel. In process block 530, if an indication that the first system has been loaded is received through the network from the device, then it is indicated through the user interface that the device is in the state in which the device is available to load an operating system selectable through the user interface. Again, in one embodiment, the first system is loaded into the random access memory of the device.

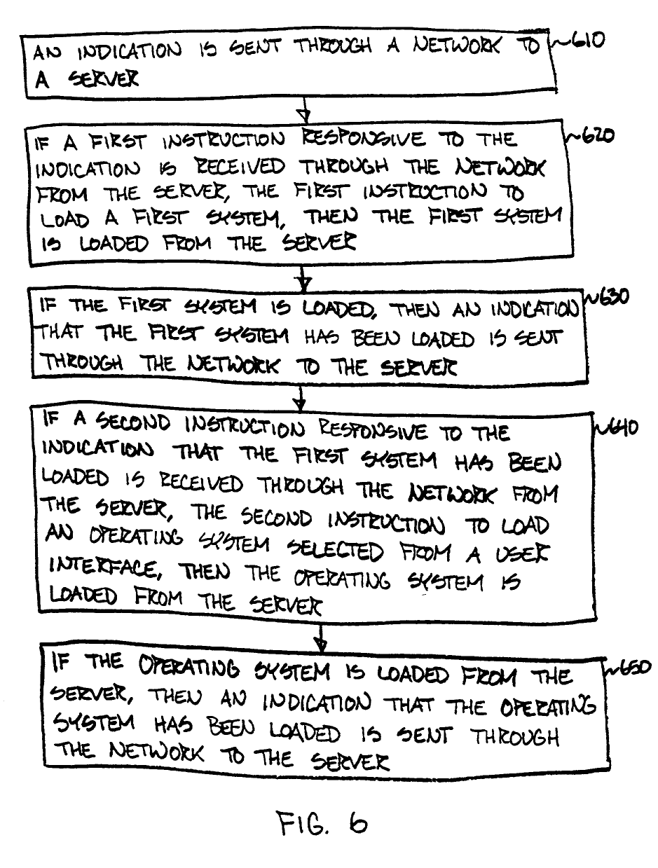

FIG. 6 illustrates a flow diagram for installing an operating system from a server through a network, according to one embodiment. In process block 610, an indication is sent through a network to a server. In process block 620, if an instruction responsive to the indication is received through the network from the server to load a first system, then the first system is loaded from the server. In process block 630, if the first system is loaded, then an indication that the first system has been loaded is sent through the network to the server. In process block 640, if an instruction responsive to the indication that the first system has been loaded is received through the network from the server to load an operating system selected from a user interface, then the operating system is loaded from the server. In process block 650, if the operating system is loaded from the server, then an indication that the operating system has been loaded is sent through the network to the server.

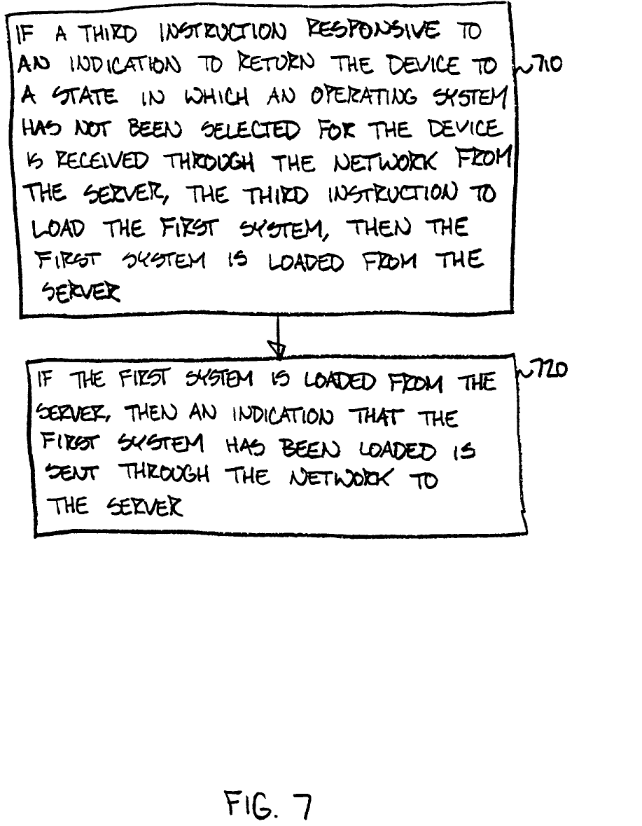

FIG. 7 illustrates a flow diagram for unprovisioning an operating system through a network from a server, according to one embodiment. In one embodiment, after an indication that the operating system has been loaded has been sent through the network to the server, as shown in process block 650 above, then in process block 710, if an instruction responsive to an indication to return the device to a state in which an operating system has not been selected for the device is received through the network from the server, the first system is loaded from the server. In process block 720, if the first system is loaded from the server, then an indication that the first system has been loaded is sent through the network to the server.

FIG. 8 illustrates a system for installing an operating system on a device through a network, according to one embodiment. A processing unit 810 is coupled to a network communication unit 820. Processing unit 810 interacts with a user interface 840. In one embodiment, this interaction is through the Internet. Network communication unit 820 is coupled to a network. Also coupled to the network is a device 830.

Network communication unit 820 is to receive through the network a first indication from device 830. Network communication unit 820 is also to instruct device 830 through the network to load a first system upon processing unit 810 determining that device 830 is in a state in which the first system has not been loaded for device 830. Network communication unit 820 is also to receive through the network from device 830 a second indication that the first system has been loaded.

Processing unit 810 is to determine from the first indication that device 830 is in a state in which the first system has not been loaded for the device. Processing unit 810 is also to indicate through user interface 840, upon network communication unit 820 receiving the second indication, that device 830 is in a state in which device 830 is available to load an operating system selectable through user interface 840. In one embodiment, processing unit 810 executes a web application to indicate through user interface 840 the provisioning state of device 830.

In one embodiment, network communication unit 820 is also to instruct device 830 through the network to load an operating system upon a selection of the operating system. In one embodiment, network communication unit 820 is to receive through the network from device 830 a second indication. The second indication is an indication that the operating system has been loaded. In one embodiment, processing unit 810 is also to indicate through user interface 840, upon network communication unit 820 receiving the second indication, that device 830 is in a state in which an operating system has been loaded for the device. In one embodiment, processing unit 810 is also to indicate through user interface 840, upon network communication 820 receiving the second indication, the operating system that has been loaded for device 830.

In one embodiment, processing unit 810 is also to indicate through user interface 840, upon network communication unit 820 receiving the second indication, that device 830 is in a state in which device 830 is available to return to the state in which an operating system has not been selected for device 830. In one embodiment, network communication unit 820 is also to instruct device 830 through the network to load the first system upon a third indication. The third indication is an indication to return device 830 to the state in which an operating system has not been selected for device 830. In one embodiment, network communication unit 820 is also to receive a fourth indication through the network from device 830. The fourth indication is an indication that the first system has been loaded. In one embodiment, processing unit 810 is also to indicate through user interface 840, upon network communication unit 820 receiving the fourth indication, that device 830 is in the state in which device 830 is available to load an operating system selectable through user interface 840.

FIG. 9 illustrates a system for installing an operating system selectable through a user interface from a server through a network, according to one embodiment. Processing unit 910 is coupled with network communication unit 920. Network communication unit 920 is coupled with a network. Also coupled with the network is a server 930. Server 930 interacts with user interface 940 as described above in reference to FIG. 8.

Network communication unit 920 is to send an indication through the network to server 930. Network communication unit 920 is also to receive through the network from server 930 a first instruction responsive to the indication. The first instruction is an instruction to load the first system. Network communication unit 920 is also to send through the network to server 930, upon processing unit 910 loading the first system, an indication that the first system has been loaded. Network communication unit 920 is also to receive from server 930 through the network a second instruction responsive to the indication that the first system has been loaded. The second instruction is an instruction to load an operating system selected from user interface 940. Network communication unit 920 is also to send through the network to server 930, upon processing unit 910 loading the operating system from server 930, an indication that the operating system has been loaded.

Processing unit 910 is to load the first system from server 930 upon network communication unit 920 receiving the first instruction. Processing unit 910 is also to load the operating system from server 930 upon network communication unit 920 receiving the second instruction.

In one embodiment, network communication unit 920 is also to receive through the network from server 930 a third instruction responsive to an indication to return the device to a state in which an operating system has not been selected for the device. The third instruction is an instruction to load the first system. In one embodiment, network communication unit 920 is also to send through the network to server 930, upon processing unit 910 loading the first system from server 930, an indication that the first system has been loaded. In one embodiment, processing unit 910 is also to load the first system from server 930 upon network communication unit 920 receiving the third instruction.

The method described above can be stored in the memory of a computer system (e.g., set top box, video recorders, etc.) as a set of instructions to be executed. In addition, the instructions to perform the method described above could alternatively be stored on other forms of machine-readable media, including magnetic and optical disks. For example, the method of the present invention could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the methods as discussed above, could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method comprising:
receiving through a network an indication from a device;
upon determining from the indication that the device is in a state in which a first system has not been loaded on the device, instructing the device through the network to load the first system; and
upon receiving through the network from the device an indication that the first system has been loaded, indicating through a user interface that the device is in a state in which the device is available to load an operating system selectable through the user interface.

2. The method of claim 1, further comprising:
upon a selection of an operating system, instructing the device through the network to load the operating system; and
upon receiving through the network from the device an indication that the operating system has been loaded, indicating through the user interface that the device is in a state in which an operating system has been loaded for the device.

3. The method of claim 2, further comprising:
upon receiving through the network from the device the indication that the operating system has been loaded, indicating through the user interface the operating system that has been loaded for the device.

4. The method of claim 2, further comprising:
upon receiving the indication that the operating system has been loaded, indicating through the user interface that the device is in a state in which the device is available to return to the state in which an operating system has not been selected for the device;
upon an indication to return the device to the state in which an operating system has not been selected for the device, instructing the device through the network to load the first system; and
upon receiving an indication through the network from the device that the first system has been loaded, indicating through the user interface that the device is in the state in which the device is available to load an operating system selectable through the user interface.

5. A method comprising:
sending an indication through a network to a server;
upon receiving through the network from the server a first instruction responsive to the indication, the first instruction to load a first system, loading the first system from the server;
upon loading the first system, sending through the network to the server an indication that the first system has been loaded;
upon receiving from the server through the network a second instruction responsive to the indication that the first system has been loaded, the second instruction to load an operating system selected from a user interface, loading the operating system from the server; and
upon loading the operating system from the server, sending through the network to the server an indication that the operating system has been loaded.

6. The method of claim 5, further comprising:
upon receiving through the network from the server a third instruction responsive to an indication to return the device to a state in which an operating system has not been selected for the device, the third instruction to load the first system, loading the first system from the server.

7. The method of claim 6, further comprising:
upon loading the first system from the server, sending through the network to the server an indication that the first system has been loaded.

8. A machine-readable medium that provides instructions that, when executed by a machine, cause the machine to perform operations comprising:
receiving through a network an indication from a device;
upon determining from the indication that the device is in a state in which a first system has not been loaded on the device, instructing the device through the network to load the first system; and
upon receiving through the network from the device an indication that the first system has been loaded, indicating through a user interface that the device is in a state in which the device is available to load an operating system selectable through the user interface.

9. The machine-readable medium of claim 8, wherein operations further comprise:
upon a selection of an operating system, instructing the device through the network to load the operating system; and
upon receiving through the network from the device an indication that the operating system has been loaded, indicating through the user interface that the device is in a state in which an operating system has been loaded for the device.

10. The machine-readable medium of claim 9, wherein operations further comprise:
upon receiving through the network from the device the indication that the operating system has been loaded, indicating through the user interface the operating system that has been loaded for the device.

11. The machine-readable medium of claim 9, wherein operations further comprise:
upon receiving the indication that the operating system has been loaded, indicating through the user interface that the device is in a state in which the device is available to return to the state in which an operating system has not been selected for the device;
upon an indication to return the device to the state in which an operating system has not been selected for the device, instructing the device through the network to load the first system; and
upon receiving an indication through the network from the device that the first system has been loaded, indicating through a user interface that the device is in the state in which the device is available to load an operating system selectable through the user interface.

12. A machine-readable medium that provides instructions that, when executed by a machine, cause the machine to perform operations comprising:
sending an indication through a network to a server;
upon receiving through the network from the server a first instruction responsive to the indication, the first instruction to load a first system, loading the first system from the server;
upon loading the first system, sending through the network to the server an indication that the first system has been loaded;
upon receiving from the server through the network a second instruction responsive to the indication that the first system has been loaded, the second instruction to load an operating system selected from a user interface, loading the operating system from the server; and
upon loading the operating system from the server, sending through the network to the server an indication that the operating system has been loaded.

13. The machine-readable medium of claim 12, wherein operations further comprise:
upon receiving through the network from the server a third instruction responsive to an indication to return the device to a state in which an operating system has not been selected for the device, the third instruction to load the first system, loading the first system from the server.

14. The machine-readable medium of claim 13, wherein operations further comprise:
upon loading the first system from the server, sending through the network to the server an indication that the first system has been loaded.

15. An apparatus comprising:
a network communication unit to receive through a network a first indication from a device, to instruct the device through the network to load a first system upon a processing unit determining that the device is in a state in which a first system has not been loaded for the device, and to receive through the network from the device a second indication that the first system has been loaded; and
the processing unit coupled with the network communication unit to determine from the first indication that the device is in a state in which the first system has not been loaded for the device, and to indicate through a user interface, upon the network communication unit receiving the second indication, that the device is in a state in which the device is available to load an operating system selectable through the user interface.

16. The apparatus of claim 15, wherein the network communication unit is also to instruct the device through the network to load an operating system upon a selection of the operating system, and to receive through the network from the device a second indication that the operating system has been loaded.

17. The apparatus of claim 16, wherein the processing unit is also to indicate through the user interface, upon the network communication unit receiving the second indication, that the device is in a state in which an operating system has been loaded for the device.

18. The apparatus of claim 17, wherein the processing unit is also to indicate through the user interface, upon the network communication unit receiving the second indication, the operating system that has been loaded for the device.

19. The apparatus of claim 17, wherein the processing unit is also to indicate through the user interface, upon the network communication unit receiving the second indication, that the device is in a state in which the device is available to return to the state in which an operating system has not been selected for the device.

20. The apparatus of claim 19, wherein the network communication unit is also to instruct the device through the network to load the first system upon a third indication to return the device to the state in which an operating system has not been selected for the device, and to receive a fourth indication through the network from the device that the first system has been loaded.

21. The apparatus of claim 20, wherein the processing unit is also to indicate through a user interface, upon the network communication unit receiving the fourth indication, that the device is in the state in which the device is available to load an operating system selectable through the user interface.

22. An apparatus comprising:
a network communication unit to send an indication through a network to a server, to receive through the network from the server a first instruction responsive to the indication, the first instruction to load a first system, to send through the network to the server, upon a processing unit loading the first system, an indication that the first system has been loaded, to receive from the server through the network a second instruction responsive to the indication that the first system has been loaded, the second instruction to load an operating system selected from a user interface, and to send through the network to the server, upon the processing unit loading the operating system from the server, an indication that the operating system has been loaded; and
the processing unit coupled with the network communication unit to load the first system from the server upon the network communication unit receiving the first instruction, and to load the operating system from the server upon the network communication unit receiving the second instruction.

23. The apparatus of claim 22, wherein the network communication unit is also to receive through the network from the server a third instruction responsive to an indication to return the device to a state in which an operating system has not been selected for the device, the third instruction to load the first system, and to send through the network to the server, upon the processing unit loading the first system from the server, an indication that the first system has been loaded.

24. The apparatus of claim 23, wherein the processing unit is also to load the first system from the server upon the network communication unit receiving the third instruction.
